(19) United States
(12) Patent Application Publication
(10) Pub. No.: US 2015/0027587 A1
(43) Pub. Date: Jan. 29, 2015

(54) Router Jig for Producing Tenons

(71) Applicant: Leslie G. Smith, Cut Bank, MT (US)

(72) Inventor: Leslie G. Smith, Cut Bank, MT (US)

(21) Appl. No.: 14/338,641

(22) Filed: Jul. 23, 2014

Related U.S. Application Data
(60) Provisional application No. 61/857,634, filed on Jul. 23, 2013.

(51) Int. Cl. B27F 1/08

(52) U.S. Cl. CPC B27F 1/08
USPC 144/203

(57) ABSTRACT

An apparatus used for cutting tenons consists of a plurality of mounting brackets, a plurality of arms, a motor, and a pair of threaded rods. The plurality of mounting brackets attaches the apparatus to an external platform. The motor is mounted onto one of the plurality of arms allowing the motor to slide along the length of the arm. The log in which the tenon is to be cut is placed in between the pair of threaded rods. By rotating the log with the use of one of the threaded rods or with the use of a drill, the log makes contact with the motor. The rotating motion of both the log and also the motor, results in a tenon being cut on the log. Additionally, two motors can also be used in tenon cutting such that a tenon with different diameters can be cut simultaneously.

The current application claims a priority to the U.S. Provisional Patent application Ser. No. 61/857,634 filed on Jul. 23, 2013.

### FIELD OF THE INVENTION

The present invention relates generally to devices used in the field of creating wood furniture. More specifically, the present invention is a router jig that can be used to conveniently create tenons on logs.

### BACKGROUND OF THE INVENTION

The mortise and tenon joint is a widely used method of joining two pieces of wood. This particular method has been a favorite among woodworkers mainly due to its simplicity and its effectiveness. The mortise and tenon joint mainly consists of a mortise hole and a tenon tongue. The tenon which is formed at the end of a log, usually referred as the rail, is inserted into a square or rectangular hole cut in the corresponding member. The tenon is formed to fit firmly within the corresponding mortise hole. Usually, the tenon has shoulders that lie flush against the surface area surrounding the mortise hole. The effectiveness of the mortise and tenon joint has resulted in it being utilized in almost all wood furniture we see today.

Traditional tenon cutters utilize drills such that the tenon needs to be eyeballed from one end of the log to the other. As a result, the tenon has a high probability to not be straight throughout the length of the log. Due to the torque of the drill, a vise is essential when cutting a tenon with a drill. Since a vise can only expand in a limited range, only a limited number of logs can be mounted onto a vise. The limited range is especially problematic when cutting tenons on a log with a larger diameter or a bent log.

Tenons can also be created with the use of a hand saw. However, using a hand saw can be stressful and is only possible for a limited number of logs. For example, cutting a tenon on a log with a larger diameter may be time consuming due to its rigidness. Similar, to cutting a tenon with a drill, a vise is an essential item when cutting a tenon with a saw. In almost all tenon cutting methods a well known issue is the inability to cut tenons of different diameters simultaneously. If a tenon with different diameters needs to be cut, the larger diameter is cut first and next the smaller diameter is cut. For time efficiency, it is vital to have the ability to use different router bits simultaneously.

Another issue that arises in tenon cutting is the strength of the user handling the log. In particular, if the log has a significant weight, users of less strength will have difficulty in controlling the log while cutting a tenon or a shoulder on the log. In unfortunate circumstances, the difficulty in handling can result in injuries to the user. Prior to cutting a tenon, the end of the log is usually cut flat. For instance, if the end is not cut as required, the log will spin out of control. As a result, there is a high probability for the log to spin out of the vise, which can be risky to the user.

The objective of the present invention is to address the aforementioned issues. In particular, the present invention allows a user to cut different shoulders on logs and also keep tenons in a straight line. Additionally, the effective design of the present invention also allows a user to cut tenons on bent logs and also cut tenons with different diameters. The present invention eliminates the need of using a vise of similar mechanical apparatus in the tenon cutting process. Furthermore, the effective design of the present invention allows users of different strengths to cut tenons with ease.

### BRIEF DESCRIPTION OF THE DRAWINGS

FIG. 1 is a perspective view of the present invention as installed on an external platform.

FIG. 2 is a top view of the present invention, wherein only one motor is utilized.

FIG. 3 is a top view of the present invention, wherein the motor has a different operational point.

FIG. 4 is a perspective view of the present invention, wherein two motors are utilized.

FIG. 5 is a top view of the present invention, wherein two motors have been utilized.

FIG. 6 is a top view of the present invention, wherein the two motors have different operational points.

FIG. 7 is a perspective view of the present invention, wherein one threaded rod is being utilized with one motor.

FIG. 8 is a perspective view of the present invention, wherein one threaded rod is being utilized with two motors.

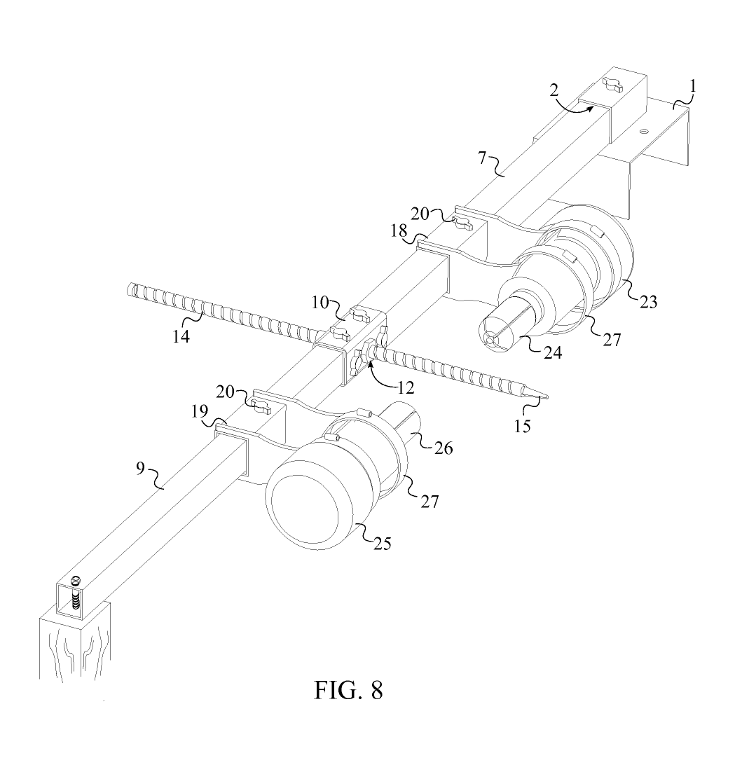

FIG. 9 is a top view of the first rod holder of the present invention.

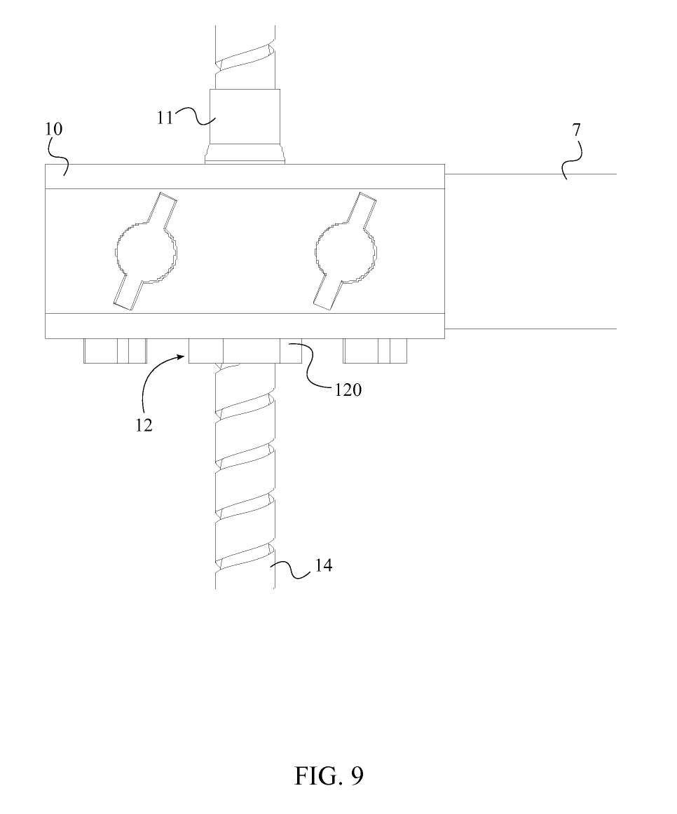

FIG. 10 is a side view of the first rod holder of the present invention.

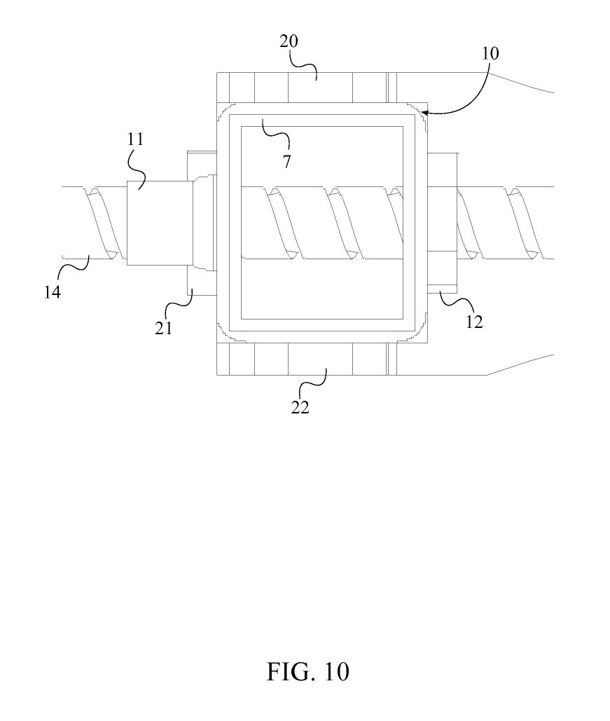

FIG. 11 is a perspective view of the motor mounting bracket of the present invention.

### DETAIL DESCRIPTIONS OF THE INVENTION

All illustrations of the drawings are for the purpose of describing selected versions of the present invention and are not intended to limit the scope of the present invention.

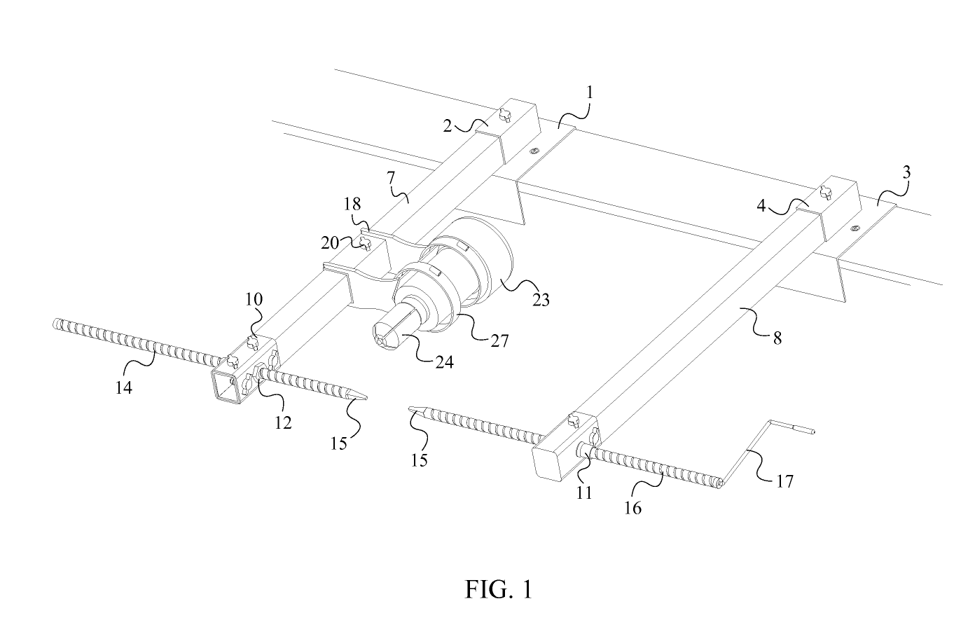

The present invention is an apparatus that can be used to cut straight tenons on logs that can vary in length, diameter, and shape. The present invention comprises a first bench mounting bracket 1, a first motor mounting bracket 18, a first motor 23, a first arm 7, a first threaded rod 14, a first rod holder 10, and a first router bit 24. As seen in FIG. 1, the first bench mounting bracket 1 is utilized to attach the present invention to an external platform such that the present invention remains steady during the tenon cutting process. The log in which a tenon is intended to be cut on, is placed adjacent to the first threaded rod 14 such that a tenon can be cut by utilizing the first router bit 24 connected to the first motor 23.

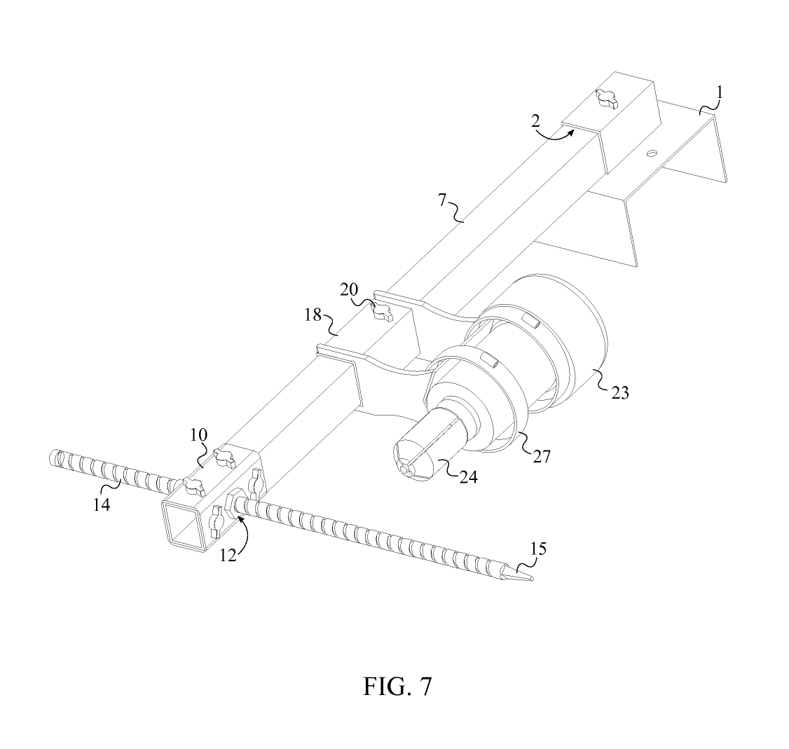

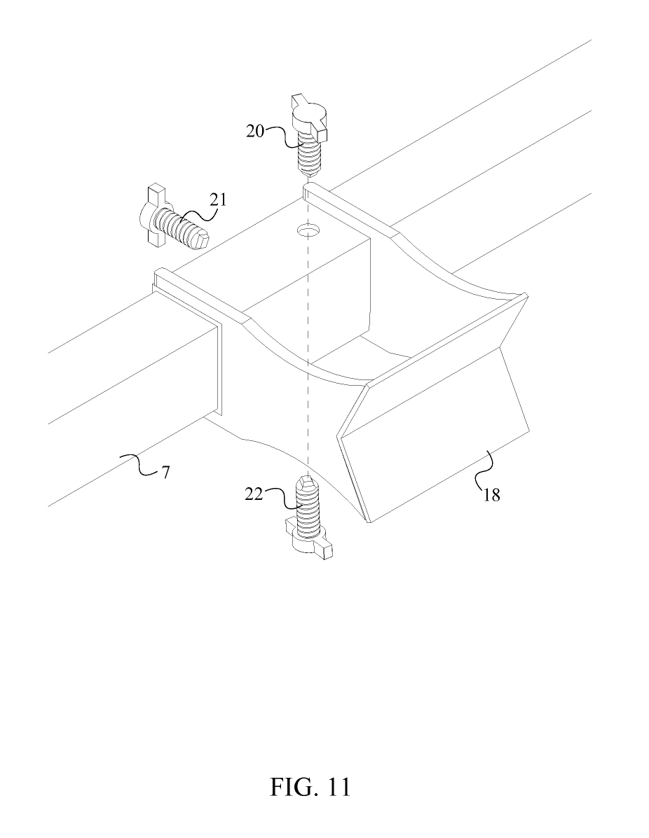

The present invention comprises a first configuration, a second configuration, and a third configuration that can all be utilized to cut a tenon or shoulder on a log. In the first configuration, the first bench mounting bracket 1 is mounted on to an external platform. Furthermore, an external rotation mechanism is utilized in the tenon cutting process. The external rotation mechanism can be, but is not limited to, a power drill or other comparable means. The bench mounting bracket 1 can be attached onto the external platform with many different methods that can be, but is not limited to, a fastener. The first arm 7 is adjacently connected to the first bench mounting bracket 1. In the preferred embodiment of the present invention, the first bench mounting bracket 1 comprises a first arm receiving slot 2. The first arm 7 is positioned into the first arm receiving slot 2 and is fastened such that the first arm 7 extends out of the first arm receiving slot 2 as illustrated in FIG. 7. The first motor mounting bracket 18 is slidably engaged along the first arm 7 such that the position of the first motor mounting bracket 18 can be changed along the first arm 7 according to the user's preference. In order to do so, the first motor mounting bracket 18 is slidably engaged onto the first arm 7 through a clamping mechanism. In the preferred embodiment of the present invention, the clamping mechanism is a first wing screw-and-nut 20, a second wing screw-and-nut 21, and a third wing screw-and-nut 22, which allows the first motor mounting bracket 18 to be locked-in-place with the first arm 7 during the tenon cutting process. The first wing screw-and-nut 20, the second wing screw-and-nut 21, and the third wing screw-and-nut 22 are all utilized in securing the first motor mounting bracket 18 on the first arm 7 such that when secured, the first wing screw-and-nut 20 is perpendicularly positioned to the second wing screw-and-nut 21. Likewise, the third wing screw-and-nut 22 is perpendicularly positioned to the second screw-and-nut 21. In the resulting position, the first wing screw-and-nut 20 is positioned parallel to the third wing screw-and-nut 22. As shown in FIG. 11, the first wing screw-and-nut 20 and the third wing screw-and-nut 22 are axially aligned to each other such that the first motor mounting bracket 18 can be slightly tilted in either vertical direction. As an example, if the first wing screw-and-nut 20 is fastened more than the third wing screw-and-nut 22, then the first motor mounting bracket 18 can be tilted downwards. Similarly, if the third wing screw-and-nut 22 is fastened more than the first wing screw-and-nut 20, the first motor mounting bracket 18 can be tilted upwards. The first motor 23 is attached onto the first motor mounting bracket 18 such that a user has the ability to interchange the first motor 23 according to personal preference. In order to assist interchangeability, the first motor 23 is attached to the first motor mounting bracket 18 with at least one hose clamp 27. However, in another embodiment of the present invention, a different attachment mechanism can also be utilized. The first router bit 24 that is used to cut a tenon on a log is axially connected the first motor 23. The first wing screw-and-nut 20 and the third wing screw-and-nut 22 are utilized to align the first router bit 24 coplanar to a central axis of the first threaded rod 14. In the first configuration, the first rod holder 10 is adjacently connected to the first arm 7, opposite the first bench mounting bracket 1. As a result, the first motor mounting bracket 18 is positioned in between the first rod holder 10 and the first bench mounting bracket 1.

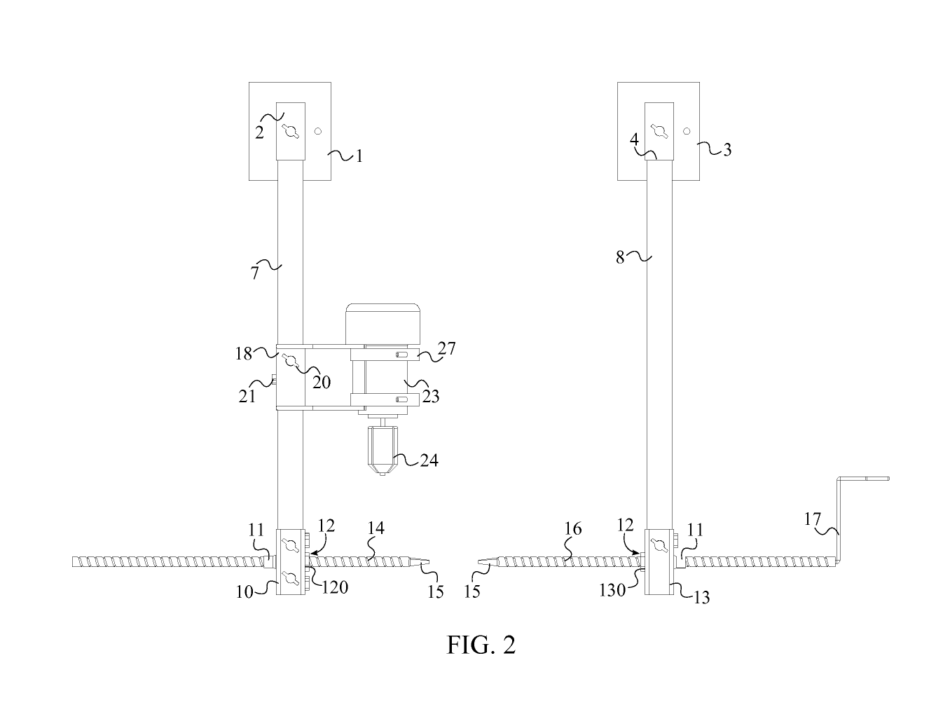

As seen in FIG. 2, the first rod holder 10 is utilized to connect the first arm 7. The first rod holder 10 comprises a first female threaded portion 120 which engages with the first threaded rod 14. More specifically, the first threaded rod 14 perpendicularly traverses through the first rod holder 10 and threadably engages with the first female threaded portion 120. In the preferred embodiment of the present invention, the first rod holder 10 further comprises a bushing 11 and a welded nut 12. The bushing 11 and the welded nut 12 provide more stability to the first threaded rod 14 and also allow the first threaded rod 14 to be in motion during the tenon cutting process. Moreover, the welded nut 12 is the first female threaded portion 120 in the preferred embodiment of the present invention. The bushing 11 is positioned adjacent the first rod holder 10. The welded nut 12 is positioned adjacent the first rod holder 10 and opposite the bushing 11. Therefore, when the first threaded rod 14 traverses through the first rod holder 10, the first threaded rod 14 is traversed through both the bushing 11 and the welded nut 12. In the resulting position of the first threaded rod 14 and the first router bit 24, the first router bit 24 is positioned adjacent to the first threaded rod 14, such that a rotation axis of the first threaded rod 14 is perpendicularly positioned to a rotation axis of the first router bit 24.

In the second configuration of the present invention, the present invention further comprises a second bench mounting bracket 3, a second arm 8, a second threaded rod 16, and a second rod holder 13 as seen in FIGS. 1-3. Similar to the first rod holder 10, the second rod holder 13 also comprises a bushing 11 and a welded nut 12. More specifically, the bushing 11 and the welded nut 12 provide stability to the second threaded rod 16 during the tenon cutting process. The second configuration allows a user to cut tenons on a bent log or peel a log. In doing so, the log is positioned in between the first threaded rod 14 and the second threaded rod 16. Similar to the first arm 7, the second arm 8 is adjacently connected to the second bench mounting bracket 3. In the preferred embodiment of the present invention, the second bench mounting bracket 3 comprises a second arm receiving slot 4. The second arm 8 is positioned into the second arm receiving slot 4. The second rod holder 13 is connected adjacent to the second arm 8 opposite the second bench mounting bracket 3. Similar to the first configuration, the second threaded rod 16 perpendicularly traverses through the second rod holder 13. In order to receive the second threaded rod 16, the second rod holder 13 comprises a second female threaded portion 130. In the preferred embodiment of the present invention, the second female threaded portion 130 is the welded nut 12. The bushing 11 is positioned adjacent to the second rod holder 13. Moreover, the welded nut 12 is positioned adjacent to the second rod holder 13 and opposite the bushing 11. Similar to the first threaded rod 14 traversing through the first rod holder 10, the second threaded rod 16 traverses through both the bushing 11 and the welded nut 12 when traversing through the second rod holder 13. Upon traversing the second rod holder 13, the second threaded rod 16 is axially aligned with the first threaded rod 14 which allows a log to be placed in between the first threaded rod 14 and the second threaded rod 16. In contrast to the first threaded rod 14, the second threaded rod 16 comprises a crank 17. The crank 17 is axially connected to the second threaded rod 16 and allows a user to rotate the log that is positioned in between the first threaded rod 14 and the second threaded rod 16. Moreover, the external rotation mechanism in the first configuration is substituted by the crank 17 in the second configuration. However, in another embodiment of the present invention, the second threaded rod 16 can comprise a square or round shaft instead of the crank 17. The square or round shaft allows a user to attach an external rotation mechanism which can be, but is not limited to, a cordless power drill.

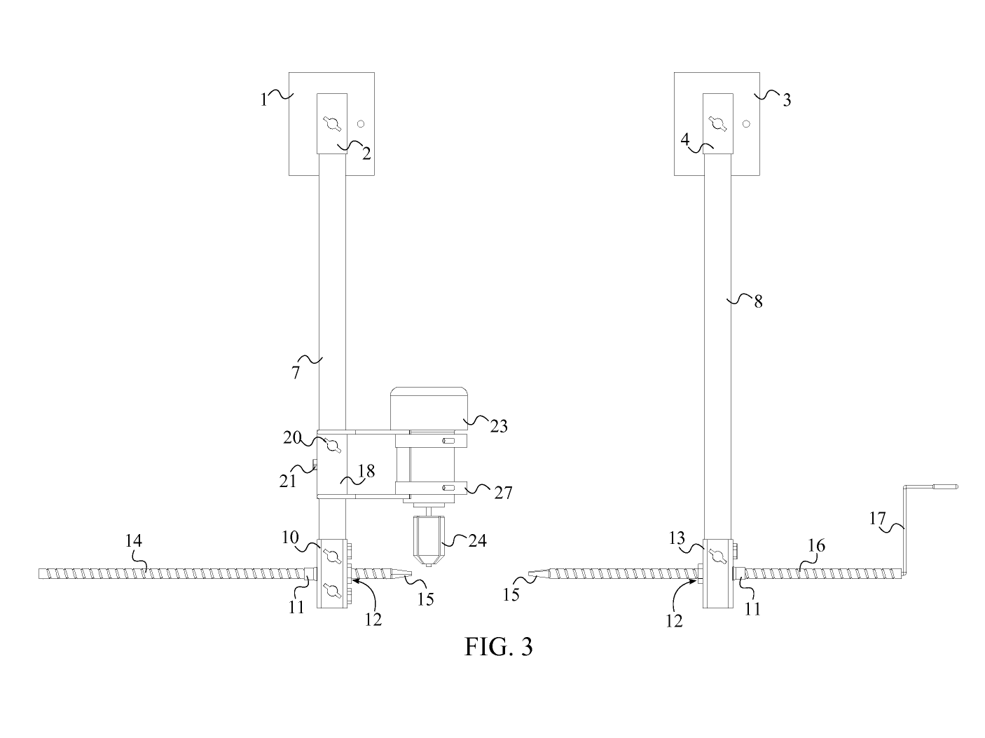

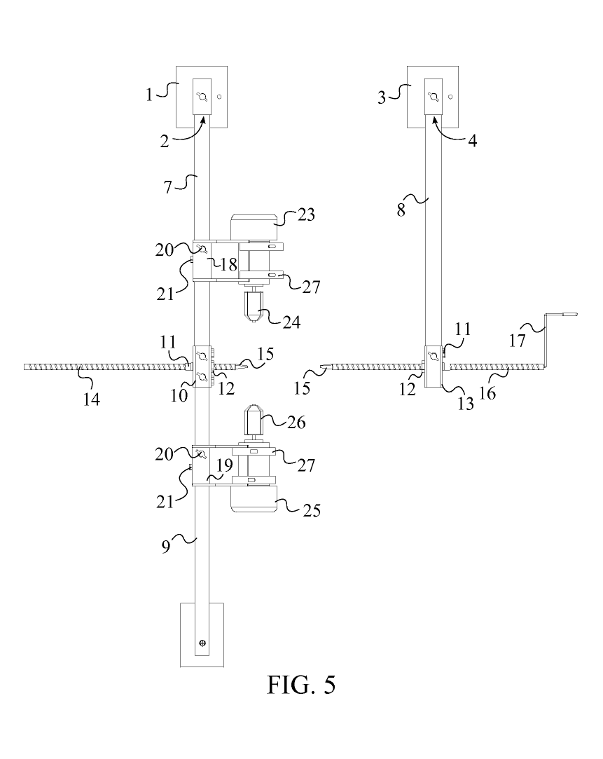

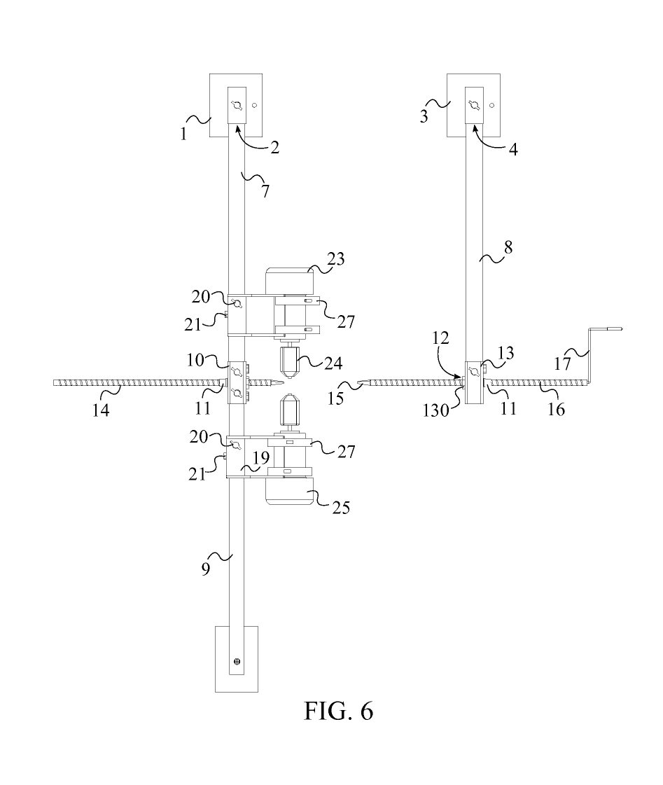

As seen in FIGS. 3-6, the log can be placed in between the first threaded rod 14 and the second threaded rod 16. In order to secure the log in between the first threaded rod 14 and the second threaded rod 16, both the first threaded rod 14 and the second threaded rod 16 each comprise a square tapered tip 15. The square tapered tip 15 of the first threaded rod 14 is oriented towards the square tapered tip 15 of the second threaded rod 16. Furthermore, the square tapered tip 15 of the second threaded rod 16 and the crank 17 are opposite to each other along the second threaded rod 16. Therefore, a user can rotate the log which is positioned in between the first threaded rod 14 and the second threaded rod 16 by rotating the crank 17.

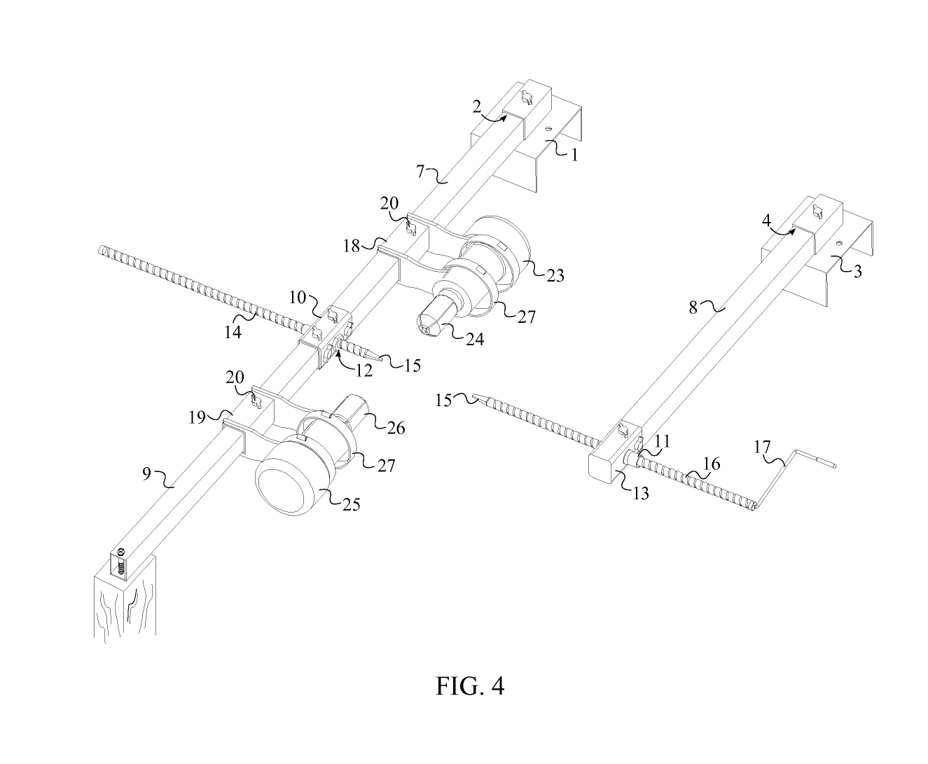

The third configuration of the present invention can be utilized to cut tenons of different diameters. As shown in FIG. 4, the present invention further comprises an additional motor 25, an additional motor mounting bracket 19, a third arm 9, and an additional router bit 26 in the third configuration. In order to cut a tenon with a different diameter, the additional router bit 26 is differently sized than the first router bit 24. Similar to the first router bit 24 being axially connected to the first motor 23, the additional router bit 26 is axially connected to the additional motor 25. The third arm 9 is adjacently connected to the first rod holder 10 opposite the first arm 7. In the resulting position the third arm 9 is positioned in parallel to the first arm 7. According to the user's preference, the third arm 9 can be connected to an external support that can be, but is not limited to, a support wood leg. As illustrated in FIG. 4, the third arm can be attached to the support wood leg through a wood screw or other comparable means. Similar, to the first configuration, the additional motor mounting bracket 19 of the third configuration is slidably engaged onto the third arm 9 adjacent to the first rod holder 10 utilizing a clamping mechanism. The clamping mechanism of the third configuration is a first wing screw-and-nut 20, a second wing screw-and-nut 21, and a third wing screw-and-nut 22. When the additional motor mounting bracket 19 is locked-in-place with the third arm 9 through the first wing screw-and-nut 20, the second wing screw-and-nut 21, and the third wing screw-and-nut 22, the first wing screw-and-nut 20 is perpendicularly positioned to the second wing screw-and-nut 21. Moreover, the third wing screw-and-nut 22 is perpendicularly positioned to the second wing screw-and-nut 21. In the resulting position, the first wing screw-and-nut 20 is positioned in parallel to the third wing screw-and-nut 22. Similar to the first motor mounting bracket 18, the first wing screw-and-nut 20 is axially aligned with the third wing screw-and-nut 22. By utilizing the first wing screw-and-nut 20 and the third wing screw-and-nut 22, the additional router bit 26 is aligned coplanar with a central axis of the first threaded rod 14. The additional motor 25 can be attached onto the additional motor mounting bracket 19 through means that can be, but is not limited to, at least one hose clamp 27. Even though the first arm 7, the second arm 8, and the third arm 9 are all used in the third configuration, the third configuration can also function with the absence of the second arm 8. In the resulting position, a rotation axis of the first threaded rod 14 is perpendicularly positioned to a rotation axis of the first router bit 24 which allows a tenon to be cut when the first router bit 24 is positioned adjacent to the first threaded rod 14. Moreover, a rotation axis of the additional router bit 26 is positioned in parallel to the rotation axis of the first router bit 24. Additionally, the rotation axis of the additional router bit 26 is offset from the rotation axis of the first router bit 24 by a radius changing distance which allows the user to cut tenons with different diameters.

In utilizing the first configuration, a user first drills a pivot hole on the ends of a log. The square tapered tip 15 of the first threaded rod 14 is inserted into one of the pivot holes on the log. Next, the first motor 23 is placed adjacent to the first threaded rod 14 such that the router bit cuts the tenon from the center of the log. Afterwards, the user attaches the external rotation mechanism to the free end of the log such that the log rotates in a clockwise or counterclockwise direction. Next, the first motor 23 is powered allowing the first router bit 24 to cut the tenon on the log. The position of the first motor 23 along the length of the first arm 7 can be adjusted as illustrated in FIG. 2 and FIG. 3. If required the third arm 9 can be connected to the first rod holder 10 along with the additional motor 25 as illustrated in FIG. 4. This allows the user to cut tenons with different diameters. In utilizing the second configuration, the square tapered tip 15 of the first threaded rod 14 is inserted to one pivot hole. The square tapered tip 15 of the second threaded rod 16 is inserted into the other pivot hole. Next, the first motor 23 is powered and the log is rotated through the crank 17 on the second threaded rod 16. Depending on the specifications of the first router bit 24, a required tenon is cut on the log. If required, the third arm 9 can also be attached such that the additional router bit 26 cuts a different diameter. By utilizing the first threaded rod 14 and the second threaded rod 16 peeling of logs of logs can also be done conveniently. Even though rotating a log, peeling a log, and all other functionalities available through the present invention are done manually in the present invention, in a future embodiment of the present invention, all functionalities can be controlled through means that can include, but is not limited to, a computer or a computer numerical control (CNC) machine.

Although the invention has been explained in relation to its preferred embodiment, it is to be understood that many other possible modifications and variations can be made without departing from the spirit and scope of the invention as hereinafter claimed.

What is claimed is:

1. A router jig for producing tenons comprises:
a first bench mounting bracket;
a first motor mounting bracket;
a first motor;
a first arm;
a first threaded rod;
a first rod holder;
a first router bit;
the first rod holder comprises a first female threaded portion;
the first arm being adjacently connected to the first bench mounting bracket;
the first rod holder being adjacently connected to the first arm, opposite the first bench mounting bracket;
the first motor mounting bracket being slidably engaged along the first arm;
the first motor mounting bracket being positioned in between the first rod holder and the first bench mounting bracket;
the first motor being attached onto the first motor mounting bracket;
the first router bit being axially connected to the first motor;
the first router bit being positioned adjacent to the first threaded rod;
the first threaded rod being threadably engaged with the first female threaded portion; and
the first threaded rod perpendicularly traversing through the first rod holder.

2. The router jig for producing tenons as claimed in claim 1, wherein a rotation axis of the first threaded rod being perpendicularly positioned to a rotation axis of the first router bit.

3. The router jig for producing tenons as claimed in claim 1 comprises:
the first bench mounting bracket comprises a first arm receiving slot; and
the first arm being positioned into the first arm receiving slot.

4. The router jig for producing tenons as claimed in claim 1, wherein the first motor mounting bracket is slidably engaged onto the first arm through a clamping mechanism.

5. The router jig for producing tenons as claimed in claim 4 comprises:
the clamping mechanism being a first wing screw-and-nut, a second wing screw-and-nut, and a third wing screw-and-nut;
the first motor mounting bracket being locked-in-place to the first arm by the first wing screw-and-nut, the second wing screw-and-nut, and the third wing screw-and-nut;
the first wing screw-and-nut being perpendicularly positioned to the second wing screw-and-nut;
the third wing screw-and-nut being perpendicularly positioned to the second wing screw-and-nut;
the first wing screw-and-nut being positioned parallel to the third wing screw-and-nut; and
the first wing screw-and-nut being axially aligned with the third wing screw-and-nut.

6. The router jig for producing tenons as claimed in claim 1, wherein the first motor is attached to the first motor mounting bracket with at least one hose clamp.

7. The router jig for producing tenons as claimed in claim 1 comprises:
the first rod holder further comprises a bushing and a welded nut;
the welded nut being the first female threaded portion;
the bushing being positioned adjacent to the first rod holder;
the welded nut being positioned adjacent to the first rod holder, opposite to the bushing; and
the first threaded rod traversing through the bushing and the welded nut.

8. The router jig for producing tenons as claimed in claim 1 comprises:
a second bench mounting bracket;
a second arm;
a second threaded rod;
a second rod holder;
the second rod holder comprises a second female threaded portion;
the second threaded rod comprises a crank;
the second arm being adjacently connected to the second bench mounting bracket;
the second rod holder being adjacently connected to the second arm, opposite the second bench mounting bracket;
the second threaded rod perpendicularly traversing through the second rod holder; and
the second threaded rod being axially aligned with the first threaded rod.

9. The router jig for producing tenons as claimed in claim 8 comprises:
the second bench mounting bracket comprises a second arm receiving slot; and
the second arm being positioned into the second arm receiving slot.

10. The router jig for producing tenons as claimed in claim 8 comprises:
the second rod holder further comprises a bushing and a welded nut;
the welded nut being the second female threaded portion;
the bushing being positioned adjacent to the second rod holder;
the welded nut being positioned adjacent to the second rod holder, opposite to the bushing; and
the second threaded rod traversing through the bushing and the welded nut;

11. The router jig for producing tenons as claimed in claim 8 comprises:
the first threaded rod and the second threaded rod each comprise a square tapered tip;
the square tapered tip of the first threaded rod being oriented towards the square tapered tip of the second threaded rod;
the square tapered tip of the second threaded rod and the crank being opposite to each other along the second threaded rod; and
the crank being axially connected to the second threaded rod.

12. The router jig for producing tenons as claimed in claim 1 comprises:
an additional motor;
an additional motor mounting bracket;
a third arm;
an additional router bit, wherein the additional router bit is differently sized than the first router bit;
the additional router bit being axially connected to the additional motor;
the third arm being adjacently connected to the first rod holder, opposite the first arm;
the third arm being positioned parallel to the first arm;
the additional motor mounting bracket being slidably engaged along the third arm, adjacent to the first rod holder; and
the additional motor being attached onto the additional motor mounting bracket.

13. The router jig for producing tenons as claimed in claim 12 comprises:
a rotation axis of the first threaded rod being perpendicularly positioned to a rotation axis of the first router bit;
a rotation axis of the additional router bit being positioned parallel the rotation axis of the first router bit; and
the rotation axis of the additional router bit being offset from the rotation axis of the first router bit by a radius-changing distance.

14. The router jig for producing tenons as claimed in claim 12, wherein the additional motor mounting bracket is slidably engaged onto the third arm with the clamping mechanism.

15. The router jig for producing tenons as claimed in claim 14 comprises:
the clamping mechanism being a first wing screw-and-nut, a second wing screw-and-nut, and a third wing screw-and-nut;
the first motor mounting bracket being locked-in-place to the third arm by the first wing screw-and-nut, the second wing screw-and-nut, and the third wing screw-and-nut;
the first wing screw-and-nut being perpendicularly positioned to the second wing screw-and-nut;
the third wing screw-and-nut being perpendicularly positioned to the second wing screw-and-nut;
the first wing screw-and-nut being positioned parallel to the third wing screw-and-nut; and
the first wing screw-and-nut being axially aligned with the third wing screw-and-nut.

16. The router jig for producing tenons as claimed in claim 12, wherein the additional motor is attached to the additional motor mounting bracket with an at least one hose clamp.
